(19) United States
(12) Patent Application Publication
(10) Pub. No.: US 2001/0054058 A1
(43) Pub. Date: Dec. 20, 2001

(54) PROCESS FOR COMBINING IN PARALLEL N SETS OF DATA

(76) Inventor: ALEXANDER DEL PINO, DARMSTADT (DE)

Correspondence Address: WESLEY W. WHITMYER, JR, ST. ONGE STEWARD JOHNSTON & REENS, LLC, 986 BEDFORD STREET, STAMFORD, CT, 06905-5919, US

(21) Appl. No.: 09/171,458

(22) PCT Filed: Jun. 27, 1997
(86) PCT No.: PCT/DE97/01338

§ 371 Date: None

(30) Foreign Application Priority Data
Jun. 27, 1996 (DE) 196 25 869.353

(51) Int. Cl. G06F 15/16; G06F 15/00; G06F 15/76

(52) U.S. Cl. 709/201; 712/20

(57) ABSTRACT

Disclosed is a process for combining in parallel N sets of data, by means of N processors (P₀, . . . , P_{N-1}), to which one set of data is allocated respectively, which are mixed together for the evaluation of the result in such a manner that each said processor accesses the sets of data of all the N−1 processors in pairs in N−1 separate steps and swaps data therewith, and a step control determines the processor pairing according to an exclusive or function.

### TECHNICAL FIELD

The present invention relates to a process for combining in parallel N sets of data comprising single data and have to be combined for calculating an overall result.

### STATE OF THE ART

The purpose of data processing procedures of the above-described type is to process large amounts of data which are available in different sets of data and have to be combined respectively mixed for calculating an overall result.

Employed for evaluation and analysis of large amounts of data are, for example, graphic representation respectively visualization of the data, which is today a key technology that allows the engineer to determine complex relationships from many fields of technology and utilize them to reach further results. An example of this is the visualization of all types of simulation results. Furthermore, also all possible kinds of sensors, for example satellites, can deliver large amounts of data that have to be visually evaluated. For this purpose, for instance, the satellites deliver sets of data containing measurements from different altitude layers of the atmosphere. In order to compose a satellite image according to desired thematic preconditions, such as by way of illustration representation of the surface topography of the earth with fields of clouds lying over it close to the ground, the sets of data from different altitude layers have to be combined and mixed in such a manner that the desired graphic final results can be calculated. All the other data from the other altitude layers have to be suppressed.

In applications in virtual environments, it is also desirable to be able to quickly depict large scenes, such as for example in all kinds of driving and training simulators.

The to-be-visualized data run through in, an as such known manner, a so-called visualizing pipeline, in which first geometry processing occurs followed by rastering. High-performance graphic computers are utilized for quick visualization of large amounts of data. Processes for parallel processing of sets of data are known which, as described in the following, can be classified in two different process groups: the so-called “screen sub-division process” and the so-called “image composition process”

In the “screen subdivision process”, as for example described in the articles by H. Fuchs: “Distributing a Visible Surface Algorithm over Multiple Computers” Proceeding of the ACM Annual Conference, 1977, pp. 449-451 and F. I. Parke: “Simulation and Expected Performance Analysis of Multiple Processor Z-Buffer Systems”, ACM Computer Graphics (Proceedings of SIGGRAPH 1980); Vol. 14, NO.3, July 1980, pp. 48-56, the entire to-be-processed image space is subdivided into individual image regions, which are allocated to individual processors of a parallel processing computer. Each processor is responsible for rastering the objects falling into the image regions allocated to it. An extreme approach is the so-called processor-per-pixel approach, in which each individual pixel of the image space is allocated to an own processor. For this see, the article by H. Fuchs, J. Goldfeather, J. P Hultquist, S. Spach, J. D. Austin, F. P. Brooks, J. G. Eyles, J. Poulton: “Fast Spheres, Shadows, Textures, Transparencies and Image Enhancements in Pixel Planes” ACM Computer Graphics (Proceedings of SIGGRAPH 1985), Vol. 19, No. 3, July 1985, pp. 111-120.

However, far more often processes are employed in which multiple pixels are allocated to a processor, such as for example in the pixel-planes 5 or in the SGI reality engine.

The aforementioned approaches are described in the articles by H. Fuchs, J. Poulton, J. Eyles, T. Greer, J. Goldfeather, D. Ellsworth, S. Molnar, G. Turk, B. Tebbs, L. Israel: “Pixel-Planes 5: A Heterogeneous Multiprocessor Graphics System Using Processor-Enhanced Memories”, ACM Computer Graphics (Proceeding of SIGGRAPH 1989), Vol. 23, No. 3, July 1989, pp. 79-88 and by K. Akeley: “Reality Engine Graphics”, ACM Computer Graphics (Proceedings of SIGGRAPH) 1993), August 1993, pp. 109-116.

Contrary to the aforementioned “screen subdivision process”, in the “image composition process”, the graphic primitives of the object space are distributed and allocated to the processors. In such processes, each processor is responsible for calculating the pixel allocated to it which are visible by the rendering of the objects allocated to it. The result is then part images that only have to be combined, like in the case of satellite image data, in which measured values from multiple altitude layers of the atmosphere lying above each other are combined to a finished satellite image.

In this case, the rendering process is a geometric transformation of the available three-dimensional sets of data into a two-dimensional image set of data. As, for calculating and representing an entire image, the graphic primitives of each set of data may cover the primitives of other sets of data in the same object space, the individual part images respectively sets of data have to be mixed in order to produce a whole image. This mixing procedure contributes to coining the term “image composition process”.

Image composition processes are so interesting, because, the addition of more processors increases the ability to visualize respectively process large amounts of data. The quick mixing of many single part images respectively sets of data is the basic problem of image composition processes. Essentially, two fundamental processes are known with which part images respectively sets of data of this type can be mixed.

The basis of one of the known processes is a pipeline, whereas another known process has a recursive tree structure.

In the known pipeline process, the processors are arrayed in a kind of pipeline, and the pixel or pixel regions and sent through this pipeline. On the way through the pipeline, the pixel regions undergo changes due to the processors participating in the process. The following articles describe known pipeline processes with which the content of a multiplicity of part images respectively sets of data can be mixed: R. Weinberg: “Parallel Processing Image Synthesis and Anti-Aliasing”, ACM Computer Graphics, vol. 15, No. 3, August 1981, pp. 55-62, M. Deering, S. Winner, B. Schediwy, C. Duffy, N. Hunt: “The Triangle Processor and Normal Vector Shader: A VLSI System for High Performance Graphics”, ACM Computer Graphics (Proceedings of SIGGRAPH 1988), vol. 22, NO. 4, August 1988, pp. 21-30 and S. Molnar, J. Eyles, J. Poulton: “Pixel Flow: High Speed Rendering Using Image Composition”, ACM Computer Graphics (Proceeding of SIGGRAPH 1992), July 1992, pp. 231-240 .

The second process operating according to a recursive tree is described in the following articles: D. Fussell, B. D. Rathi: “A VLSI-Oriented Architecture for Real-Time Raster Display of Shaded Polygons”, Proceedings of Graphics Interface 82, Toronto, May 1982, pp. 373-380, S. Molnar, H. Fuchs: “Advanced Raster Graphics Architecture” in: J. D. Foley, A. van Dam, S. K. Feiner, J. F. Hughes: “Computer Graphics: Principles and Practice”, 2^{nd} Edition, Addison-Wessley, Reading, Mass., 1990, pp. 855-922 and R. Scopigno, A. Paoluzzi, S. Guerrini, G. Rumolo: “Parallel Depth Merge: A Paradigm for Hidden Surface Removal”, Computers & Graphics, vol. 17, No. 5, 1993, pp. 583-592 .

In the known processes according to the pipeline principle, the latency rises disadvantageously, i.e. the time, dependent on the length of the pipeline, between the time of entry of the to-be-mixed pixel respectively pixel information and the available result, the more processors are provided in the pipeline. Moreover, the so-called pipeline processes do not permit scaleable data processing, as is the case with parallel processes. In the processes that operate according to a “recursive tree structure”, the available processors are only insufficiently utilized the further the process progresses.

### DESCRIPTION OF THE INVENTION

The object of the present invention is to provide a process for combining in parallel N sets of data in such a manner that the information from single sets of data to be combined in parallel processing to a common result are mixed as fast as possible while utilizing all the available components. The process should, in particular, be applicable in the visualization of sets of data and possess scaleable properties. In particular, the process should be accelerated by all the available processors participating during the entire course of the process, i.e. from the beginning to the end of the process. The possibility should be created that efficient high-performance computers can be built with which the calculating procedure, i.e. the swapping and mixing of single data from the N sets of data for creating a individual overall result, can be accelerated.

The solution of the present invention is set forth in claim 1. Further features that advantageously enhance the inventive concept are the subject matter of the subclaims.

An element of the present invention is to design a process for parallel combination of N sets of data in such a manner that one set of data is allocated to each of the N processors. The N sets of data are mixed in such a manner that for evaluation, each processor accesses the sets of data of all N−1 processors in N−1 separate steps in pairs respectively and swaps these data, with a step control determining processor pairing according to an exclusive or function.

Each processor comprises at least one microprocessor, which can process the sets of data in its local memory and, in addition, a connection to a communication network via which a processor can access the memory of another processor. In this manner, a processor pair can swap data. In the literature (also see I. Stomenovic: “Direct Interconnection Networks”, appeared in A. Zomaya (ed.), “Parallel & Distributed Computing Handbook” McGraw-Hill, 1996; T. -Y. Feng: “A Survey of Interconnection Networks”, IEEE Computer, vol. 14, No. 12, December 1981, pp. 12-27), in this context the term “knot” is frequently used for processors interconnected in this manner.

The invented process starts at the point where N processors have already generated N different part images respectively sets of data which have to be combined for a graphic end product to be composed. These N processors are interconnected in such a manner that any processors can swap their data. An important aspect of the present invention is that multiple processors can access the part images respectively sets of data simultaneously, i.e. in parallel and independently. A step control calculates which processor can access which data.

If a whole graphic image is to be calculated, the image space is conceptually subdivided into N regions R₀, . . . , R_{N-1}, size and property of the regions being of no relevance for the process. In particular, the regions do not have to be connected. Each of the to-be-processed regions is allocated to a specific processor which is responsible for calculating the pixel of the region. allocated to the finished image. However, to do so, it lacks the pixel of this region from N−1 other processors. By way of illustration, reference is made to a case study for calculating a satellite image on which data from different altitude layers are visibly represented. Therefore, in order to calculate a whole satellite image, information from different altitude layers have to be interconnected in order to represent these data on a single image.

Assuming that N is a second power, N−1 steps S1, . . . , S_{N-1} are conducted.

In the following, Rⁱⱼ is the j^{th} image region Rⱼ of the i^{th} processor Pᵢ and Eⁱⱼ stands for the result in the j^{th} process step Sⱼ on the i^{th} processor Pᵢ. As initial part result Eⁱ_{O}, each processor Pᵢ possesses the region allocated to it of its local part image:

Eⁱ_{O}=Rᵢⁱ

In each step, the processor pairs swap image regions and then mix them to their own part results. In each step, each processor has a different partner processor. The step control determines by means of a step counter the current partner processor of P in the i^{th} step Sᵢ by means of the exclusive or function and is therefore:

P_{i\mathring{x}j}

The step control can be realized centrally as well as distributed. Each processor knows exactly from the operation step of the step counter which data it requires from which partner processor. The two processors of a processor pair (Pⱼ, P_{i\mathring{x}j}) namely swap the image region for which the other partner is respectively responsible:

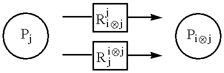

After this swapping procedure in step Sᵢ is completed, all the processors Pⱼ mix the image region received from its partner with its local part result to a new part result. This mixing function is expressed here by the Z operator:

E^{j}ᵢ=E^{j}ᵢ₋₁Z R^{partner}

The described process is not dependent on the type of mixing processes employed. After N−1 steps, each processor Pⱼ possesses as the result E^{j}_{N-1} the correctly mixed image region for which it is responsible.

The manner of proceeding further depends on whether these last results are recorded in a memory which the video controller can access directly or not. In the first instance, it is finished and in the second instance, the regions still have to be combined. For this purpose, the results can be combined on a processor using Log₂(N) steps, for example, by means of a tree-shaped organized data transport.

Although in the preceding it was assumed that steps S₁, . . . ,S_{N-1} are conducted in this ascending order, this is not a necessity. Steps S₁, . . . ,S_{N-1} can be conducted in any desired permutation, as the final result is ultimately independent of the permutation of the steps.

Furthermore, hitherto it has been assumed that the number of used processors N corresponds to a second power. This, too, is not a necessity, because in the event that N is not a second power, only two conditions change: the number of required steps is no longer N−1, but rather the same as would be required for the next higher second power of processors, therefore:

₂┌Log₂(N)┐₋₁

Moreover, it can happen that in the i^{th} step S₁ when finding the processor partner of Pⱼ, a processor results that does not exist, because

i\mathring{x}j≧2N

applies. In this case, processor Pⱼ pauses in step Sᵢ.

The invented process described in the preceding is predominantly conducted for calculations the final results of which represent visual images. However, data from various fields of application can be combined and interconnected with the invented process.

By means of the invented controlled pairing with selective data swapping in each case between a pair of processors, data can be economically swapped in the quickest manner between all the processors participating in the process procedure so that after N−1 steps all the processors receive all the data they require to calculate their final part results. For further processing of the final whole result, only the final part results of each individual processor need to be combined.

### BRIEF DESCRIPTION OF THE DRAWINGS

The present invention is made more apparent in the following, by way of example without the intention of limiting the overall inventive idea, using a preferred embodiment with reference to the drawing. Shown is in:

FIG. 1 a diagrammatic representation of the components of the hardware involved in the invented process,

FIG. 2 a representation of processor pairing in the form of a table, and

FIG. 3 a schematic diagram of the course of the invented process.

### DESCRIPTION OF PREFERRED EMBODIMENTS

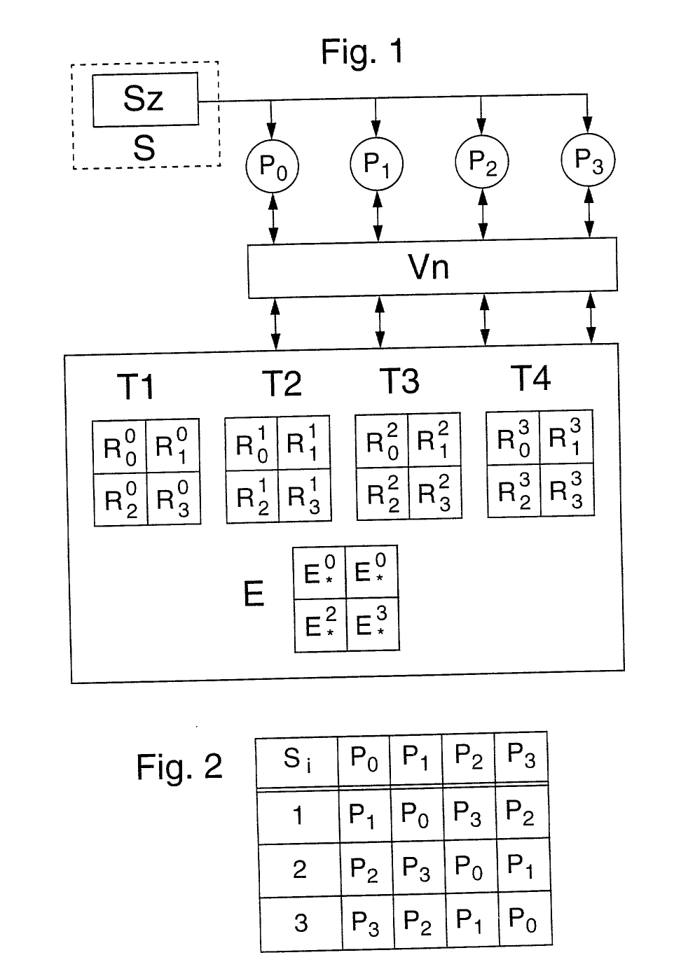

FIG. 1 shows the hardware components involved for conducting the process. In the present case, N=4 processors P₀, P₁, P₂, P₃ are connected to a common memory Sₚ via a connecting network Vn. Four part images T1, T2, T3 and T4 are stored in memory Sₚ. The image space of each part image is subdivided into four rectangular regions R₀, R₁, R₂, R₃. As already explained in the preceding, the lower index always corresponds to the pertinent image region within the individual part image and the upper index corresponds to the processor allocation. In the present case, the image regions Ro in the individual part images T1 to T4 are processed by processor P₀. The same applies for regions R₁, R₂, and R₃. A result set of data E, in which the part results per processor are recorded following data swapping, is also provided in memory Sₚ. With the aid of a step counter Sz, step control module S controls processor pairing and, in addition, determines in which step which data are swapped between which processors.

In the shown example for N=4 processors, N−1=3 time steps are to be conducted so that each processor interconnects with all the other ones. FIG. 2 shows a table according to which the step counter conducts processor pairing. The purpose of the step control is that in the i^{th} operation step S₁ for each process Pⱼ with j=0, 1, 2, 3 that current partner processor with which the image region is to be swapped can be calculated.

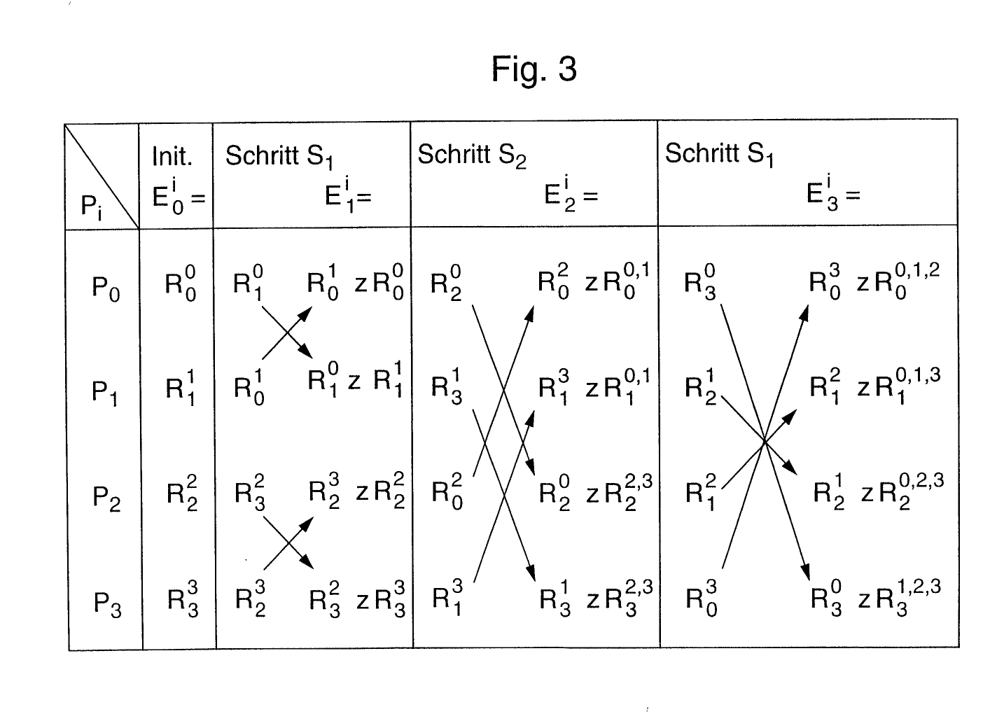

The course diagram according to FIG. 3 shows the mixing steps conducted after each swapping procedure between two pairs of processors.

In the left column the four individual processors P₀ to P₃ are listed one below the other. The original image regions R₀ to R₃ from the part images T1 to T4 are allocated to the respective individual processors. In a first step S₁, for instance, processor P₀ receives the data of the image region R₀ from processor P₁ and mixes them with the data of image region R₀ which have already been allocated to it. Furthermore, for example, in the first process step S₁, processor P₃ receives the data of image region R₃ from processor P₂. These data of image region R₃ coming to it, processor P₃ mixes with the already available data R₃. The Z operator represents here in each case the mixing procedure after the completed swapping procedure in the individual processors.

In a second step S₂ another data swap occurs according to the process pairing shown in FIG. 2. Thus, for instance, processor P₁ obtains the data of image region R₁ from processor P₃ and mixes them with its already stored data of image regions R₁. On the other hand, for example, processor P₁ delivers the data of image region R₃ to processor P₃, which mixes these with its already stored data R₃. The same applies to the last step S₃.

Above of all it must be pointed out that during the entire data swapping procedure, all the processors P₀ to P₃ operate parallel, i.e. operate simultaneously side by side. The invented process therefore utilizes all the available hardware components up to the last process step, which for instance is not the case in the process operating according to the recursive tree principle.

The following comparison of the time required for the calculation of the whole image of the invented process and the known processes shows that the invented process leads to a result considerably quicker than the known ones.

If A is the image size, T(A) are the costs for the transfer of the A-pixels, C(A) are the costs for mixing A-pixels and N is the number of utilized processors, the time to mix an image by a binary tree is calculated according to the following formula:

Log₂(N)*(T(A)+C(A))

The time required for the calculation of a whole image using a pipeline process in which the image space is subdivided into R regions is calculated according to the following formula:

(1+(N−1)/R)*(T(A)+C(A))

A corresponding estimation of the required time calculation of the invented process for determining a whole image can be given by the following context:

((N−1)/N)*(T(A)* C(A))

In the case of the abovedescribed process with N=4 processors, the following relationship for the entire time required T_{Gesamt} applies:

T_{Gesamt}=0.75*T(A)+0.75*C(A)

In this example, a pipeline which subdivides the image space into 100 regions would require about 37% more time and a binary tree based mixing process 166% more.

Another advantage of the invented process over the pipeline process is that the resulting image is not available piece by piece but rather the participating processors end the image mixing at the same time, similar to the binary tree process.

What is claimed is:

1. A process for combining in parallel N sets of data, by means of N processors (P₀, . . . , P_{N-1}), to which one set of data is allocated respectively, which are mixed together for the evaluation of the result in such a manner that each said processor accesses the sets of data of all said N−1 processors in pairs in N−1 separate steps and swaps data therewith, and a step control determines said processor pairing according to an exclusive or function.

2. A process according to claim 1,
characterized by the fact that said sets of data are subdivided into N regions (R₀, . . . , R_{N-1}), and that each of said N regions is allocated to one processor for calculating the single data contained in said regions for the evaluation of the result.

3. A process according to claim 2,
characterized by the fact that said data swapping between one pair of processors respectively occurs in such a manner that only the data of those regions of the sets of data allocated to said processors are swapped which are being processed by the respective partner processor.

4. A process according to claim 2 or 3,
characterized by the fact that after a data swap with a partner processor all the single data accessible to a processor for the calculation of the region allocated to it are mixed respectively integrated.

5. A process according to one of the claims 1 to 4,
characterized by the fact that said step control is provided with a step counter which determines per step the current partner processor for a processor.

6. A process according to claim 5,
characterized by the fact that said step counter selects the regions from the sets of data swapped between said partner processors.

7. A process according to one of the claims 1 to 6,
characterized by the fact that said sets of data are part images, which are mixed together in order to compose a whole image.

8. A process according to claim 7,
characterized by the fact that said single data are image pixels.

9. A process according to one of the claims 1 to 8,
characterized by the fact that in the event that N is a second power, all said N processors in all said N−1 steps participate in said swapping procedure simultaneously.

10. A process according to one of the claims 2 to 9,
characterized by the fact that said determination of the data, corresponding to the regions to-be-processed by said processors, to be swapped by a processor pair occurs according to said exclusive or function.
